(19) United States
(12) Patent Application Publication
(10) Pub. No.: US 2009/0086511 A1
(43) Pub. Date: Apr. 2, 2009

(54) CONVERTER CIRCUIT WITH PULSE WIDTH FREQUENCY MODULATION AND METHOD THEREOF

(75) Inventor: Yu-Tong Lin, Hsinchu (TW)

Correspondence Address: J C PATENTS, INC., 4 VENTURE, SUITE 250, IRVINE, CA, 92618, US

(73) Assignee: PHISON ELECTRONICS CORP., Hsinchu (TW)

(21) Appl. No.: 11/862,790

(22) Filed: Sep. 27, 2007

(51) Int. Cl. H02M 3/335; H02M 7/5383

(52) U.S. Cl. 363/21.01; 363/74

(57) ABSTRACT

A converter circuit is provided herein. In the converter, a voltage converting unit receives an input voltage and outputs an output voltage according to the magnitude of the input voltage by switching operation based on a control clock signal. A comparing circuit generates a power good pulse signal by comparing the output voltage with a reference voltage. A pulse width frequency modulation circuit receives the power good pulse signal and a source clock signal to provide the control clock signal. The pulse width of the source clock signal is varied gradually and the frequency of the source clock signal is also changed during a period that the power good pulse signal remains in the first logic state, and the pulse width frequency modulated source clock signal is output as the control clock signal.

### BACKGROUND OF THE INVENTION

1. Field of the Invention

The present invention relates to a converter circuit. More particularly, the present invention relates to a converter circuit with pulse width frequency modulation, a method thereof, and a controller therewith.

2. Description of Related Art

A converter such as a DC-to-DC converter is a device that accepts a direct current (DC) input voltage and produces a DC output voltage. Typically the output produced is at a different voltage level than the input. In addition, DC-to-DC converters are used to provide noise isolation, power bus regulation, etc.

There are three main converters circuit designs. These converter circuits determine the magnitude and polarity of the output voltage for a given input voltage. The first converter, a buck regulator, is a forward converter in which the average output voltage is less than the input voltage. Second is a boost regulator which is a stored energy converter wherein the average output voltage is greater than the input voltage. Finally, the third converter, a buck-boost regulator, is also a stored energy converter in which the output voltage may be either less than or greater in magnitude than the input voltage.

FIG. 1 shows an example of a conventional buck-boost circuit for controlling the level of the output voltage. As in a buck-boost circuit 100 of FIG. 1, a comparator 140 is used to compare a voltage level at a node 132 and a voltage level of a predetermined reference voltage V_{ref}. The voltage level of the node 132 is provided by the output voltage Vₒᵤₜ through a voltage divider composed of resistors R1 and R2, as shown. When the voltage level of the node 132 reaches the voltage level of the reference voltage V_{ref}, an output signal C2 of the comparator 140 turns off a switch S5, so that the clock signal C1 is stopped from providing. On the contrary, when the voltage level of the node 132 is lower than the reference voltage V_{ref}, the output signal C2 of the comparator 140 turns on the switch S5, so that the clock signal C1 is provided to enable the buck-boost circuit 100 to be operated. Therefore, when the potential of the output voltage Vₒᵤₜ is higher enough, the clock signal C1 can be stopped providing and unnecessary power consumption will be reduced. The output voltage Vₒᵤₜ will equal to Vᵢₙ*(R1+R2)/R2. When the output voltage Vₒᵤₜ is pumped to the desired voltage level, the switch S5 will be turned on or be turned off frequently because the load at the output terminal of buck-boost circuit 100 still exists. Such switching operation of the switch S5 may be turned on at a short pulse time width. The short time pulse width may generate high frequency noise at Vₒᵤₜ, the phenomenon is shown in FIG. 1 as referred to the number 101. So the signal quality for the output voltage Vₒᵤₜ is influenced accordingly, and thus, noises are existed in the output voltage Vₒᵤₜ.

### SUMMARY OF THE INVENTION

A converter circuit with a pulse width frequency modulation (PWFM) mechanism is provided herein. In the pulse width frequency modulation mechanism, the pulse width of the clock applied to the frequency modulation unit for operation is modulated to vary gradually, for example, with a step-size mechanism. That is, the increment or decrement of the pulse width and the frequency of the applied clock is under control in relation to the output characteristic of the converter circuit.

In one embodiment, a converter circuit of the invention includes a voltage converting unit, a comparing circuit, and a pulse width frequency modulation circuit. The voltage converting unit receives an input voltage and outputs a output voltage according to the magnitude of the input voltage by switching operation based on a control clock signal. The comparing circuit generates a power good pulse signal by comparing the output voltage with a reference voltage, if the output voltage is larger than the reference voltage, the power good pulse signal is in a first logic state. A pulse width frequency modulation circuit receives the power good pulse signal and a source clock signal to provide the control clock signal. The pulse width of the source clock signal is varied gradually with a step-size mechanism and the frequency of the source clock signal is also changed during a period that the power good pulse signal remains in the first logic state, and the pulse width frequency modulated source clock signal is output as the control clock signal.

In one embodiment, the pulse width frequency modulation circuit comprises a pulse width modulation unit, which comprises a plurality of serially connected delay units, and the input of the serially connected delay units is coupled to the source clock signal. The pulse width of the source clock signal is varied gradually with the step-size mechanism by the number of the delay units the source clock signal passes, and a pulse modulated signal is generated from the pulse width modulation unit.

The above pulse width modulation unit further comprises a plurality of switches, each of which is respectively interposed between the output of each of the delay units and the output of the pulse width modulation unit through a first logic gate, by controlling the switches, the pulse modulated signal with different pulse width is generated thereby.

In one embodiment, the pulse width frequency modulation circuit comprises a bidirectional shifting circuit, for proving a plurality of control signals to controlling the switches to being turned on or being turned off.

The above bidirectional shifting circuit receives a trigger clock pulse and a directional clock pulse, the bidirectional shifting circuit is triggered to operate based on the trigger clock pulse, and the control signals are shifted according to the directional clock pulse, thereby the pulse width of the pulse modulated signal is varied.

In one embodiment, the pulse width frequency modulation circuit comprises a counting circuit for counting the times when the power good pulse signal remains in the first logic state and outputting the directional clock pulse and the trigger clock pulse, whenever the times reaches a predetermine value, the directional clock pulse from the counting circuit is activated. The invention provides a controller, adaptive to be interfaced between a memory device and a host which provides a host power. The controller comprising a DC-to-DC power manager, for regulating the host power to a power adaptive to operation of the memory device. The DC-to-DC power manager comprises an aforesaid converter circuit with a pulse width frequency modulation (PWFM) mechanism.

In order to make the aforementioned and other objects, features and advantages of the present invention comprehensible, preferred embodiments accompanied with figures is described in detail below.

### BRIEF DESCRIPTION OF THE DRAWINGS

FIG. 1 shows a conventional buck-boost circuit.

FIG. 2 shows a buck-boost circuit including a buck-boost unit and a frequency modulation unit with a function of controlling a frequency of a control clock signal.

FIG. 3A shows a buck-boost circuit including a pulse width frequency modulation mechanism of an embodiment of the invention.

FIG. 3B shows a timing diagram of the buck-boost circuit of FIG. 3A.

FIG. 4 shows a circuit for illustrating a bidirectional shifting mechanism of an embodiment of the invention.

FIG. 5 shows a circuit illustrating an embodiment of a counting mechanism provided in the buck-boost circuit of the invention.

FIG. 6A and 6B shows schematic block diagrams of a converter circuit of an embodiment of the present invention.

FIG. 7 shows a timing diagram of the converter circuit using pulse width frequency modulation of FIG. 6.

FIG. 8 shows schematic a diagram of a converter circuit of another embodiment of the present invention.

FIG. 9 shows a timing diagram of the converter circuit using the pulse width frequency modulation of FIG. 8.

FIG. 10 shows a circuit for illustrating a bidirectional shifting mechanism of another embodiment of the invention with a soft start function and short circuit protection function.

FIG. 11 shows a schematic diagram of a multi media card (MMC) with the DC-to-DC power manager of an embodiment of the present invention.

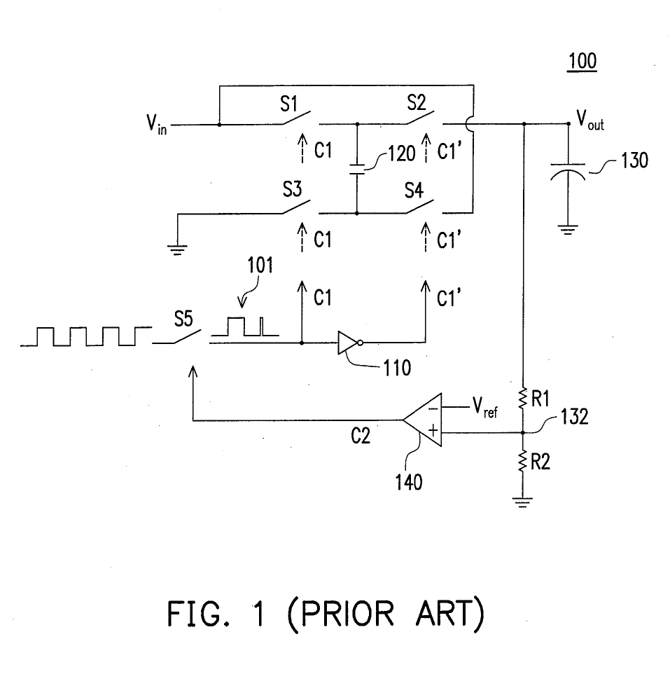

### DESCRIPTION OF EMBODIMENTS

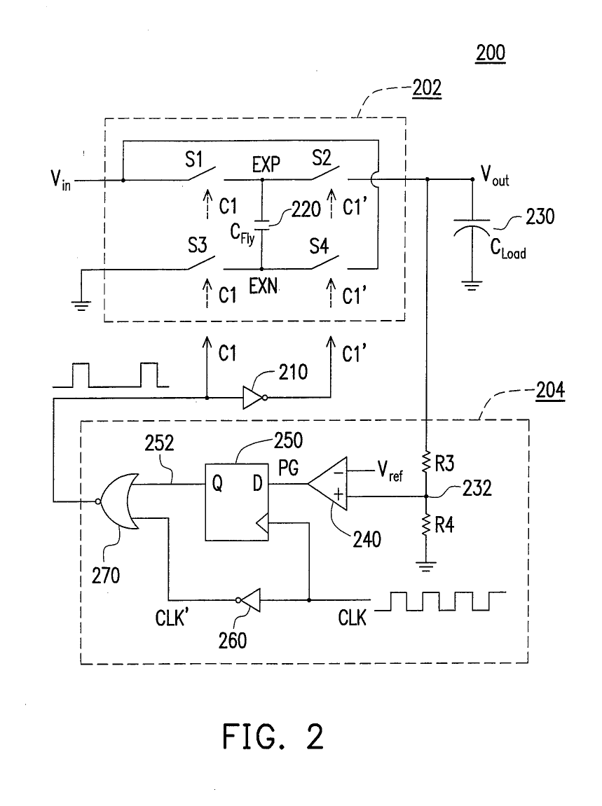

In order to avoid the noises problems in the conventional DC-DC voltage converter, for example, a buck circuit, a boost circuit, or a buck-boost circuit of FIG. 2, a frequency modulation mechanism is provided for controlling, instead of stopping from providing the clock signals if the output voltage of the buck-boost circuit is larger than a predetermined value.

For example, in the buck-boost circuit with the frequency modulation mechanism, the output voltage can be adjusted by changing the frequency of the control clock signal. For example, as shown in FIG. 2, a buck-boost circuit 200 including a buck-boost unit 202 and a frequency modulation unit 204 is introduced herein by providing a circuit for controlling the frequency of the control clock signal. In the buck-boost unit 202, a clock signal C1 controls switches S1 and S3, and a complementary signal C1′ obtained by inverting the phase of the clock signal C1 with an inverter 210 controls switches S2 and S4. When the clock signal C1 is at a high logic level, the switches S1 and S3 are turned on for conducting (ON), and the switches S2 and S4 are turned off for conducting (OFF). A potential at a node EXP, connected to one terminal of a switching flying capacitor 220, is increased to an input voltage Vᵢₙ by charging the capacitor 220. When the clock signal C1 is at a low logic level, the switches S1 and S3 are turned off, and the switches S2 and S4 are turned on. At this time, a node EXN connected to another terminal of the capacitor 220 is coupled to the input voltage Vᵢₙ through the switch S4, and the potential difference between the two terminals of the capacitor 220 is also remained as the input voltage Vᵢₙ. Therefore, the potential of the node EXP is expected to be raised to twice of the input voltage Vᵢₙ, and the output voltage Vₒᵤₜ becomes twice of the input voltage Vᵢₙ after the switch S2 is turned on and a load capacitor 230 is charged to the expected output voltage Vₒᵤₜ.

A reference voltage V_{ref} is provided to control the level of the output voltage Vₒᵤₜ, if a desired level of the output voltage Vₒᵤₜ is not as large as twice of the input voltage. The frequency modulation unit 204 is used to control the frequency of the clock signal C1, thereby, the increase rate of the potential of the output voltage Vₒᵤₜ is under control. The frequency modulation unit 204, in one embodiment, includes a comparator 240, a D-type flip-flop 250, an inverter 260, and a NOR gate 270, for example.

As shown in FIG. 2, a positive input terminal of a comparator 240 is coupled to a node 232, and a negative terminal of the comparator 240 is coupled to a predetermined reference voltage V_{ref}. If the voltage level of the node 232, coupled to the output voltage Vₒᵤₜ through a voltage divider composed of resistors R3 and R4, reaches the reference voltage V_{ref}, a clock pulse PG (power good signal) output from the comparator 240 is at a low logic level; and if the voltage level of a node 232 is lower than the reference voltage V_{ref}, the signal PG from the comparator 240 is at a high logic level.

Based on the clock pulse PG; the frequency of a clock signal C1 applied to the buck-boost unit 202 will be changed accordingly. A clock signal CLK is provided as an operation clock for the frequency modulation unit 204. The clock signal CLK is provided to control the operation of a D-type flip-flop 250, i.e., the falling edge or the rising edge of the clock signal CLK triggers the D-type flip-flop 250 to transmit an input signal (at an input terminal D) to an output terminal Q. A logic operation is performed by the NOR gate 270 on the output signal 252 of the D flip-flop 250 (the signal at the output end Q) and a complementary clock signal CLK′ obtained after inverting the clock signal CLK by the inverter 260, and the frequency-modulated signal C1 is obtained to control the switches in the buck-boost unit 202.

Because the comparator 240 outputs a PG signal, it indicates that the output voltage Vₒᵤₜ may have been overcharged during the operation period of the control mechanism. In order to prevent the output voltage Vₒᵤₜ from having excessive high amplitude, the capacitance of the capacitor 230 is generally much greater than that of the capacitor 220. Therefore, when the potential of the output voltage Vₒᵤₜ is raised to twice of the input voltage Vᵢₙ, the voltage division effect of the capacitor 230 is used to reduce the level of the output voltage Vₒᵤₜ. It is assumed that the capacitance of the capacitor 220 is C_{Fy}, and the capacitance of the capacitor 230 is C_{Load}, the initial output voltage is Vₒᵤₜ₁, and the output voltage Vₒᵤₜ₂ is the voltage after the voltage division effect of the capacitors 220 and 230. The reduced output voltage Vₒᵤₜ₂ is equal to Vₒᵤₜ₂=(Vₒᵤₜ₁*C_{Load}+2Vᵢₙ*C_{Fly})/(C_{Load}+C_{Fly}).

However, if the buck-boost circuit 200 is applied to scale-down devices, for example, to a micro memory card with a very small size requirement, the thickness of the buck-boost circuit 200 is restricted, which means that the maximum available capacitance for the capacitor 230 is also restricted. The restriction makes the application of the buck-boost circuit 230 difficult to be used in the scale-down devices, which are more and more popular in the field.

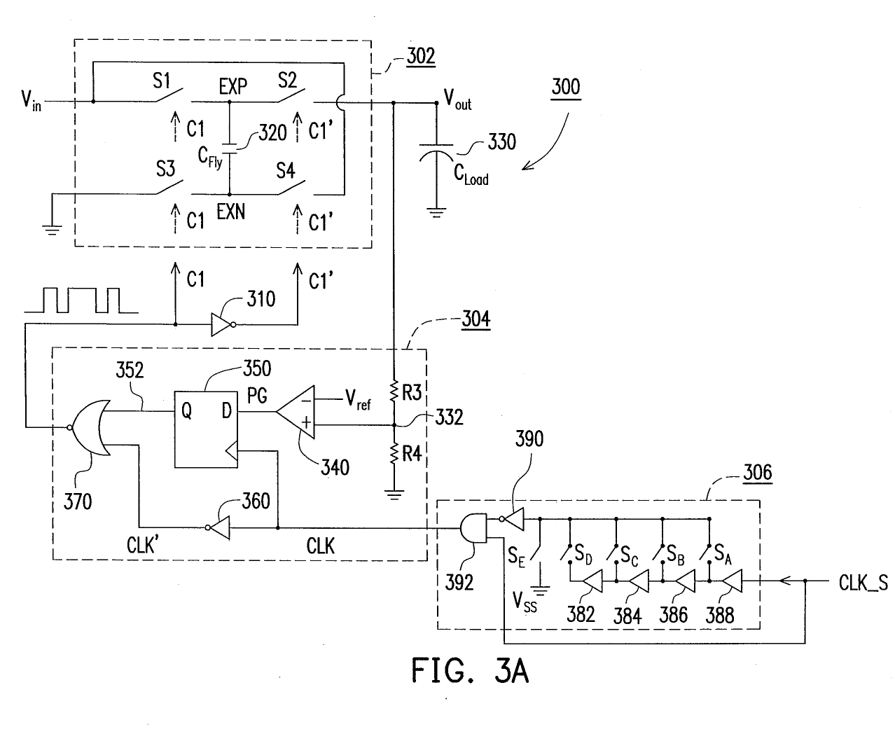

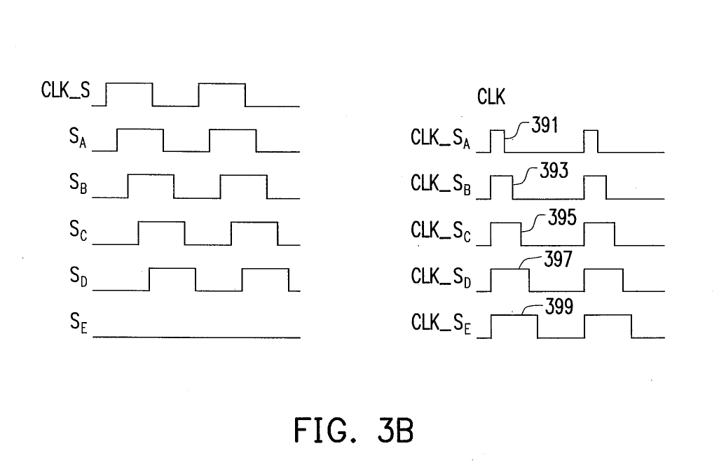

A voltage converter circuit with a pulse width frequency modulation mechanism is provided herein. Taking the example as shown in FIG. 3A, a large capacitance of the load capacitor 230 at the output terminal of the buck-boost circuit 200 is not required, which makes the buck-boost circuit 200 can be applied to various electric devices, including the scale-down small devices. In the pulse width frequency modulation mechanism, the control clock signal is under control not only with the frequency, but also with the pulse width.

The pulse width modulation mechanism provided in the present invention is gradually increasing or decreasing the pulse width of the clock applied to the frequency modulation unit for operation. That is, the increment or decrement of the pulse width of the applied clock is under control, which depends on the voltage level of the output of the buck-boost circuit.

In one embodiment, the pulse width modulation mechanism can be implemented by counting the time width of the PG status, which depends on comparing the output voltage with a predetermined reference voltage. If the PG status remains at a logic high level for over, for example, five times after counting, the pulse width of the applied clock is decreased with a predetermined value, in order to decrease the pumping charge amount of the buck-boost circuit. If the PG status remains at the logic high level for over five times after counting again, it means that the output voltage level of the buck-boost circuit is still remained too high than desired, the pulse width of the applied clock is again decreased with the same predetermined value in order to decrease the pumping charge amount of the output. If the PG status changes its phase and remains at the logic low level for over five times after counting, the pulse width of the applied clock is increased for the same predetermined value.

The predetermined value for increasing or decreasing the pulse width of the applied clock depends on the capacitance of the load capacitor at the output of the buck-boost circuit. Using the mechanism such as a step-size variation for changing the pulse width of the clock is the reason that if the frequency for changing the pulse width is not so high, the output voltage of the buck-boost circuit is clean, which means that noises in the output of the buck-boost circuit is significantly reduced.

Please refer to FIG. 3A, which shows a buck-boost circuit 300 of an embodiment of the present invention. The buck-boost circuit 300 including a buck-boost unit 302 and a frequency modulation unit .304 is introduced herein by providing a circuit for controlling the frequency of the control clock signal. In the buck-boost unit 302, a clock signal C1 controls switches S1 and S3, and a complementary signal C1′ obtained by inverting the phase of the clock signal C1 with an inverter 310 controls switches S2 and S4. When the clock signal C1 is at a high logic level, the switches S1 and S3 are turned on for conducting (ON), and the switches S2 and S4 are turned off for conducting (OFF). A potential at a node EXP, connected to one terminal of a switching flying capacitor 320, is increased to an input voltage Vᵢₙ by charging the capacitor 320. When the clock signal C1 is at a low logic level, the switches S1 and S3 are turned off, and the switches S2 and S4 are turned on. At this time, a node EXN connected to another terminal of the capacitor 320 is coupled to the input voltage Vᵢₙ through the switch S4, and the potential difference between the two terminals of the capacitor 320 is also remained as the input voltage Vᵢₙ. Therefore, the potential of the node EXP is expected to be raised to twice of the input voltage Vᵢₙ, and the output voltage Vₒᵤₜ becomes twice of the input voltage Vᵢₙ after the switch S2 is turned on and a load capacitor 330 is charged to the expected output voltage Vₒᵤₜ.

A reference voltage V_{ref} is provided to control the level of the output voltage Vₒᵤₜ, if a desired level of the output voltage Vₒᵤₜ is not as large as twice of the input voltage. The frequency modulation unit 304 is used to control the frequency of the clock signal C1, thereby, the increase rate of the potential of the output voltage Vₒᵤₜ is under control. The frequency modulation unit 304, in one embodiment, includes a comparator 340, a D-type flip-flop 350, an inverter 360, and a NOR gate 37, for example.

As shown in FIG. 3A, a positive input terminal of a comparator 340 is coupled to a node 332, and a negative terminal of the comparator 340 is coupled to a predetermined reference voltage V_{ref}. If the voltage level of the node 332, coupled to the output voltage Vₒᵤₜ through a voltage divider composed of, for example, resistors R3 and R4, reaches the reference voltage V_{ref}, a clock pulse PG (power good signal) output from the comparator 340 is at a low logic level; and if the voltage level of a node 332 is lower than the reference voltage V_{ref}, the signal PG from the comparator 340 is at a high logic level.

Based on the clock pulse PGQ the frequency of a clock signal C1 applied to the buck-boost unit 302 will be changed accordingly. A clock signal CLK is provided as an operation clock for the frequency modulation unit 304. The clock signal CLK is provided to control the operation of a D-type flip-flop 350, i.e., the falling edge or the rising edge of the clock signal CLK triggers the D-type flip-flop 350 to transmit an input signal (at an input terminal D) to an output terminal Q. A logic operation is performed by the NOR gate 370 on the output signal 352 of the D flip-flop 350 (the signal at the output end Q) and a complementary clock signal CLK′ obtained after inverting the clock signal CLK by the inverter 360, and the frequency-modulated signal C1 is obtained to control the switches in the buck-boost unit 302.

Because the comparator 340 outputs the PG signal, it indicates that the output voltage Vₒᵤₜ may have been overcharged during the operation period of the control mechanism. In order to prevent the output voltage Vₒᵤₜ from having excessive high amplitude, the capacitance of the capacitor 330 is generally much greater than that of the capacitor 320. Therefore, when the potential of the output voltage Vₒᵤₜ is raised to twice of the input voltage Vᵢₙ, the voltage division effect of the capacitor 330 is used to reduce the level of the output voltage Vₒᵤₜ.

The buck-boost circuit 300 further includes a pulse width modulation unit 306. The clock signal CLK provided to the frequency modulation unit 304 as an operation clock is modulated with different pulse width by the pulse width modulation unit 306. In one embodiment, the pulse width modulation unit 306 includes a plurality of serially connected delay units, a plurality of switches, an inverter 390 and a logic AND gate 392. For explanation, four serially connected delay units 382, 384, 386 and 388 and five switches S_{A}, S_{B}, S_{C}, S_{D} and S_{E} are introduced herein for example, but not limited thereto. The input of the delay unit 388 is coupled to a clock signal CLK_S, and the output of the delay unit 388 is coupled to the input of the delay unit 386. These delay units are serially connected and outputs of these delay units are respectively coupled to the input of the inverter 390 through the switches S_{A}, S_{B}, S_{C} and S_{D}. The input of the inverter 390 is also coupled to a voltage Vss through the switch SE. The output of the inverter 390 is coupled to one of inputs of the AND gate 392. Another input of the inputs of the AND gate 392 is coupled to the clock signal CLK_S. The five switches S_{A}, S_{B}, S_{C}, S_{D} and S_{E} are controlled to modulate the pulse width of the clock signal CLK provided to the frequency modulation unit 304.

Please refer to FIG. 3B, which shows a timing diagram the clock signal CLK with different pulse width under controlled by the status of turning on or turning off of the switches S_{A}, S_{B}, S_{C}, S_{D} and S_{E}. If the switch S_{D} is turned on for conducting the source clock signal CLK_S to the inverter 390, and the other switches S_{A}, S_{B}, S_{C} and S_{E} are turned off, the source clock signal CLK_S is delayed by these serially connected delay units 382, 384, 386 and 388, and then output to the input of the AND gate 392 through the inverter 390. The clock signal CLK from the pulse width modulation unit 306 is modulated with the pulse width as the clock signal 397 which is designated as “CLK_SD” as shown in FIG. 3B. As the same manner, if the switch S_{C} is turned on for conducting the source clock signal CLK_S to the inverter 390, and the other switches S_{A}, S_{B}, S_{D} and S_{E} are turned off, the source clock signal CLK_S is delayed by these serially connected delay units 384, 386 and 388, and the clock signal CLK is modulated with the pulse width as the clock signal 395 which is designated as “CLK_S_{C}”, as shown in FIG. 3B. If the switch S_{B} is turned on and the other switches S_{A}, S_{C}, S_{D} and S_{E} are turned off, the source clock signal CLK_S is delayed by these serially connected delay units 386 and 388, and the clock signal CLK is modulated with the pulse width as the clock signal 393 which is designated as “CLK_S_{B}”, as shown in FIG. 3B. If the switch S_{A} is turned on and the other switches S_{B}, S_{C}, S_{D} and S_{E} are turned off, the source clock signal CLK_S is delayed by the delay unit 388, and the clock signal CLK is modulated with the pulse width as the clock signal 391 which is designated as “CLK_S_{A}”, as shown in FIG. 3B. If the switch S_{E} is turned on and the other switches S_{A}, S_{B}, S_{C} and S_{D} are turned off, the clock signal CLK is modulated with the full clock pulse width of the source clock signal CLK_S as the clock signal 399, which is designated as “CLK_S_{E}”, as shown in FIG. 3B.

In order to avoid the noise problem if the pulse width is varied suddenly and frequently with a large value, the buck-boost circuit 300 of the invention also provides a mechanism to sequentially increase or decrease a pulse width of a source clock, in an embodiment, it can be achieved by step-size variation. The total variation of the pulse width depends on the number of stages of the serially connected delay units. In one embodiment, the “step-size” is a pulse width corresponding to the delay time between two adjacent delay units as mentioned above. The delay time depends on the capacitance of the load capacitor at the output of the buck-boost circuit. Taking the example shown in FIG. 3B, the pulse width of the source clock signal CLK_S is changed sequentially from the clock signal 391 to the clock signal 399. The source clock signal CLK_S is shifted from the clock signal 391, sequentially to the clock signal 393, 395, 397 and 399, or is shifted from the clock signal 399, sequentially to the clock signal 397, 395, 393 and 391. In the buck-boost circuit 200 of FIG. 2, if it is assumed that the capacitance of the capacitor 220 is C_{Fly}, and the capacitance of the capacitor 230 is C_{Load}, the initial output voltage is Vₒᵤₜ₁, and the output voltage Vₒᵤₜ₂ is the voltage after the voltage division effect of the capacitors 220 and 230. The reduced output voltage Vₒᵤₜ₂ is equal to Vₒᵤₜ₂=(Vₒᵤₜ₁*C_{Load}+2Vin*C_{Fly})/(C_{Load}+C_{Fly}). However, in the buck-boost circuit 300 of FIG. 3, a mechanism is provided to sequentially increase or decrease a pulse width of a source clock. If it is assumed that the capacitance of the capacitor 320 is C_{Fly}, and the capacitance of the capacitor 330 is C_{Load}, the initial output voltage is Vₒᵤₜ₁, and the output voltage Vₒᵤₜ₂ is the voltage after the voltage division effect of the capacitors 320 and 330. The reduced output voltage Vₒᵤₜ₂ is equal to Vₒᵤₜ₂={Vₒᵤₜ₁*C_{Load}+[1+(1/N)]Vin*C_{Fly}}/(C_{Load}+C_{Fly}), where N is the number of the stages of the serially connected delay units, as shown in FIG. 3A. Every variation between neighboring stages is (1/N)*Vin, which is the step-size variation of the embodiment. Thus, under the condition that noises in the output voltages are the same for the buck-boost circuits, the capacitance C_{Load} of the capacitor 330 in FIG. 3 is required to be (1/N) of that in the CLoad of the capacitor 230 in FIG. 2.

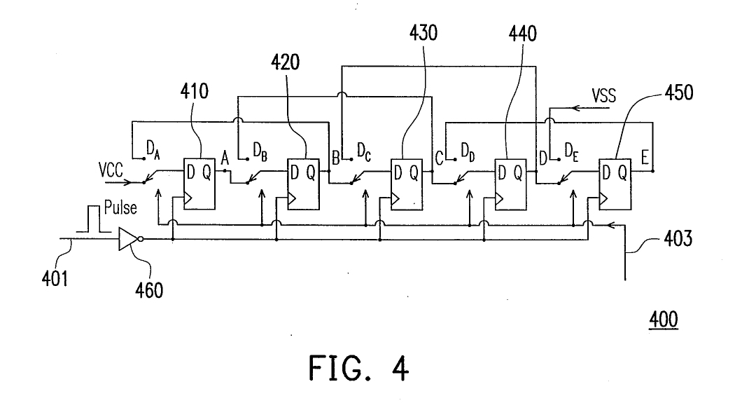

For achieving the function of shifting the output of the pulse width modulation unit 306 sequentially, a bidirectional shifting mechanism is provided in the buck-boost circuit 300 of the invention. In one embodiment, the bidirectional shifting mechanism can be achieved by providing control signals to the switches S_{A}, S_{B}, S_{C}, S_{D} and S_{E}, which is illustrated later in FIG. 4.

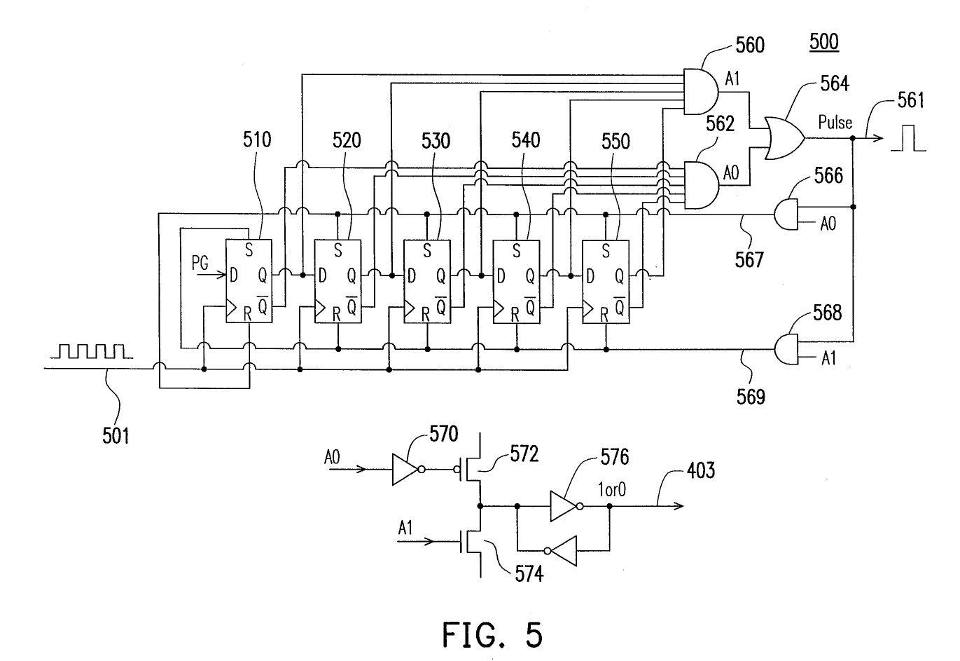

For achieving the function of shifting the output of the pulse width modulation unit 306 at a right direction, that is, to increase or to decrease the pulse width of the output of the pulse width modulation unit 306, a counting mechanism is provided in the buck-boost circuit 300A of the invention. In one embodiment, the counting mechanism uses the power good clock pulse PG as a reference. The power good clock pulse PG is obtained by comparing the output voltage with a predetermined reference voltage. In the embodiment, the counting mechanism counts the times when the status of the power good clock pulse PG remains in the same status. For example, if a predetermined times is reached by counting when the PG remains in the “high” status, the pulse width of the source clock signal CLK_S is changed by a sequence from the clock signal 399 to the clock signal 391, that is, is decreased with the a predetermined value. If the counter counts the determined times when the PG remains in the “low” status, the pulse width of the source clock signal CLK_S is changed by a sequence from the clock signal 391 to the clock signal 399, that is, is increased with the predetermined value. The counting mechanism will be illustrated in details later in FIG. 5.

The pulse width frequency modulation mechanism provided in the buck-boost circuit of the invention buck-boost circuit employs a frequency modulation mechanism and a pulse width modulation mechanism with a left-right shifting mechanism and a counting mechanism. The output voltage of the buck-boost circuit can be clean, which means that noises in the output of the buck-boost circuit are significantly reduced.

Referring to FIG. 4, a schematic circuit for illustrating a bidirectional shifting mechanism of an embodiment of the invention is provided. The signals at nodes A, B, C, D and E are provided to respectively control the switches S_{A}, S_{B}, S_{C}, S_{D} and S_{E} as shown in FIG. 3B. The bidirectional shifting circuit 400 includes five registers 410, 420, 430, 440 and 450, five two-way switches D_{A}, D_{B}, D_{C}, D_{D} and D_{E}, an inverter 460.

In the embodiment, the registers 410, 420, 430, 440 and 450 are implemented with D-type flip-flops. In one embodiment, a multiplex can be used to replace the two-way switch. A trigger pulse 401 is applied to each of the registers 410, 420, 430, 440 and 450 of the bidirectional shifting circuit 400, and a direction clock pulse 403 is applied to these two-way switches D_{A}, D_{B}, D_{C}, D_{D} and D_{E} for controlling the direction of shifting. The trigger pulse 401 is used to trigger the operation of the registers 410, 420, 430, 440 and 450. The direction clock pulse 403 is used to control the input of the registers 410, 420, 430, 440 and 450 being coupled to an operation voltage VCC (for register 410) or the output of the adjacent register (for registers 420, 430, 440 and 450), or alternatively being coupled to the output of the register next to the adjacent register (for registers 410, 420, 430 and 440) or a ground voltage VSS (for register 450).

The two-way switch D_{A} is used to couple the input of the register 410 alternatively to the operation voltage VCC or to output of the register 420. The two-way switch DB is used to couple the input of the register 420 alternatively to output of the register 410 or to output of the register 430. The two-way switch D_{C} is used to couple the input of the register 430 alternatively to output of the register 420 or to output of the register 440. The two-way switch D_{D} is used to couple the input of the register 440 alternatively to output of the register 430 or to output of the register 450. The two-way switch D_{E} is used to couple the input of the register 450 alternatively to the ground voltage VSS or to output of the register 440.

Please refer to FIG. 5, which shows a circuit illustrating an embodiment of a counting mechanism provided in the buck-boost circuit of the invention. The trigger pulse 401 and the direction clock pulse 403 of FIG. 4 are generated, for example, by the counting circuit 500. The generated trigger pulse is used to trigger the bidirectional shifting circuit 400, and the generated direction clock pulse is used to control the shifting direction of the bidirectional shifting circuit 400. The counting circuit 500 includes a serially connected D-type flip flop (DFF) units 510, 520, 530, 540 and 550, logic AND gates 560, 562, 566 and 568, a logic OR gate 564, an inverter 570, a PMOS transistor 572, a NMOS transistor 574 and a latch circuit 576.

A counting clock 501, which, in one example, may the same as the source clock signal CLK_S, is applied to the counting circuit 500 to trigger the operation of the DFF units 510, 520, 530, 540 and 550. The frequency of the counting clock 501 can determine the frequency of counting in the counting circuit 500. An input D terminal of the DFF unit 510 is coupled to a clock pulse PG (a power good signal PG output from the comparator 340 of FIG. 3B). Outputs of Q terminals of the serially connected DFF units 510, 520, 530, 540 and 550 are connected to inputs of the AND gate 560. Outputs of Q terminals of the serially connected DFF units 510, 520, 530 and 540 are also respectively connected to inputs of the next stage DFF units 520, 530, 540 and 550. Outputs of /Q (complementary to Q terminal) terminals of the serially connected DFF units 510, 520, 530, 540 and 550 are connected to inputs of the AND gate 562. Both of outputs A1 and A0 of the AND gates 560 and 562 are coupled to inputs of the OR gate 564, and the trigger pulse 561 is generated accordingly.

The trigger pulse 561 is also coupled to one input of the AND gate 566 and one input of the AND gate 568. Another input of the AND gate 566 is coupled to the output A0 of the AND gate 562. Another input of the AND gate 568 is coupled to the output A1 of the AND gate 560. The output 567 of the AND gate 566 is coupled to set terminal (“S” as shown) of the DFF units 510, 520, 530, 540 and 550. The output 569 of the AND gate 568 is coupled to reset terminal (“R” as shown) of the DFF units 510, 520, 530, 540 and 550.

The output A0 of the AND gate 562 is coupled to a gate of the PMOS transistor 572 through the inverter 570. The output A1 of the AND gate 560 is coupled to a gate of the NMOS transistor 574, and one terminal of the latch circuit 576 is connected to a point interconnecting between the MOS transistor 572 and the NMOS transistor 574. The direction clock pulse 403 is generated to control the shifting direction of the bidirectional shifting circuit of FIG. 4.

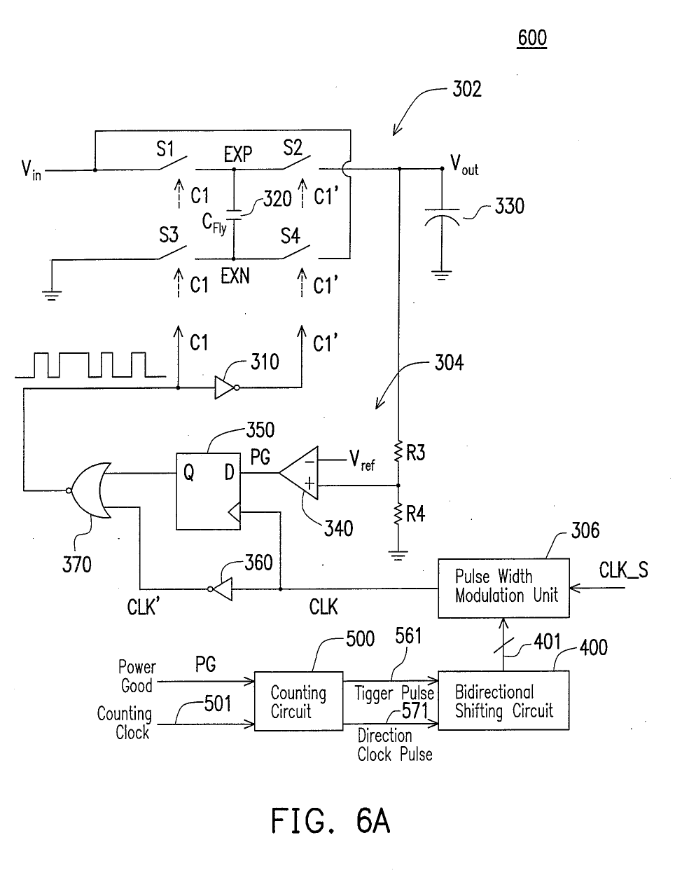

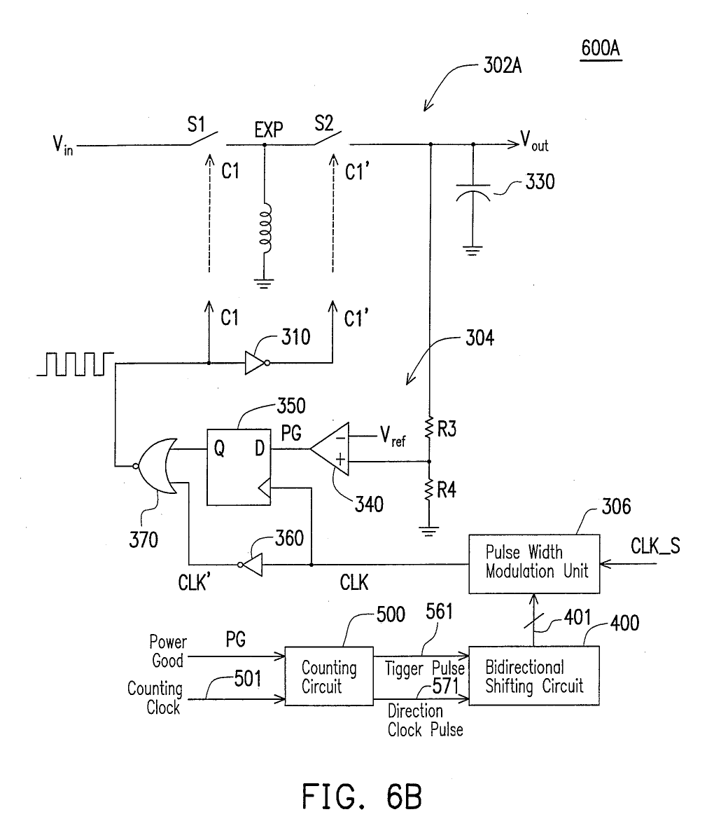

Please refer to FIG. 6A, which shows a schematic block diagram of a converter circuit of an embodiment of the present invention. In one embodiment, the converter circuit 600 includes a buck-boost unit 302, a frequency modulation unit 304 and a pulse width modulation unit 306, a bidirectional shifting circuit 400, a counting circuit 500. The elements or signals of FIG. 6A with the same function as described in FIG. 3B, FIG. 4 and FIG. 5 are denoted as the same reference number, and corresponding description can be referenced above.

By counting a power good pulse PG from the frequency modulation unit 304 based on a counting clock, a trigger pulse 561 and a direction clock pulse 571 are generated accordingly. The trigger pulse 561 and direction clock pulse 571 are applied to bidirectional shifting circuit 400. The received trigger pulse 561 is used to trigger the bidirectional shifting circuit 400, and the generated direction clock pulse is used to control the shifting direction of the bidirectional shifting circuit 400. A source clock CLK_S is applied to pulse width modulation unit 306, and under the control of a plurality of control signals 401 from the bidirectional shifting circuit 400, a modulated clock CLK is applied to the frequency modulation unit 304 for operation of frequency modulation. A control clock C1, generated after the pulse width modulation and the frequency modulation being performed upon the source clock CLK_S, is applied to the buck-boost unit 302 for voltage converting operation. By controlling switches S1, S2, S3 and S4 in the buck-boost unit 302, a converted output voltage Vₒᵤₜ is obtained.

In another embodiment, the buck-boost unit 302 of FIG. 6A can be replaced with a buck regulator, a boost regulator, a buck-boost regulator, or any kind of DC-DC converters. Inductors can be used in the buck-boost unit 302, or in the buck regulator, boost regulator, buck-boost regulator or the DC-DC converters, instead of using capacitors as the energy storing means. For example, FIG. 6B shows a schematic block diagram of a converter circuit of another embodiment of the present invention. The converter circuit 600A includes a buck-boost unit 302A, a frequency modulation unit 304 and a pulse width modulation unit 306, a bidirectional shifting circuit 400, a counting circuit 500. The elements with the same reference number in FIG. 6A and FIG. 6B perform the same function and corresponding descriptions are referred to the aforesaid descriptions. In the converter circuit 600A, a control clock C1, generated after the pulse width modulation and the frequency modulation being performed upon the source clock CLK_S, is applied to the buck-boost unit 302A for voltage converting operation. By controlling switches S1 and S2 in the buck-boost unit 302A, a converted output voltage Vₒᵤₜ is obtained.

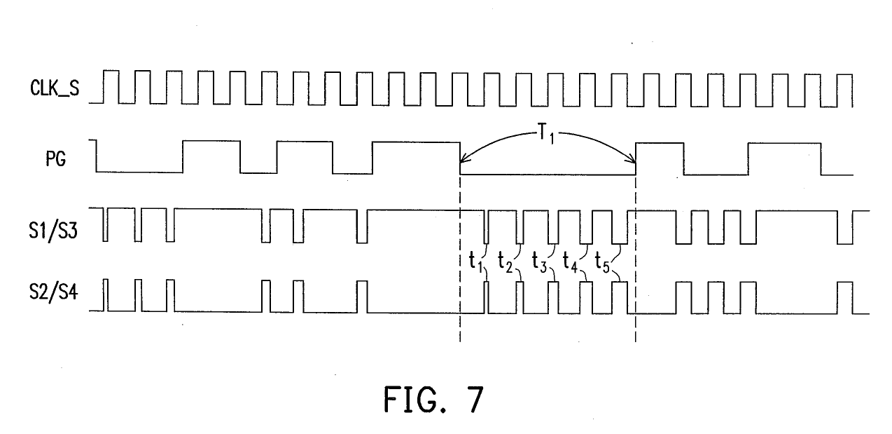

Please refer to FIG. 7, which shows a timing diagram of the converter circuit 600 using pulse width frequency modulation of FIG. 6. It is apparent that if the status of the clock pulse PG remains in a logic low, the switches S1, S2, S3 and S4 of the buck-boost unit 302 will change their phases more frequently. In addition, if the period that the clock pulse PG remains in logic low becomes longer, the period that the switches S1 and S3 remain in logic low will also become longer, and the period that the switches S2 and S4 remain in logic high will also become longer. As shown in FIG. 7, during the period T1 that the clock pulse PG remains in logic low, it is five times that the switches S1/S3 and S2/S4 change their phases, and the periods that the switches S1/S3 remain in logic low or the switches S2/S4 remain in logic high become more and more large, that is, t5>t4>t3>t2>t1.

As shown in the waveforms of the clock pulse PG for controlling ON/OFF of the switches SW1/SW3 and the switches SW2/SW4, the time width for the switches SW1/SW3 (or the switches SW2/SW4) to be switched between ON and OFF is directly influenced by the frequency and the width of the occurrence of the clock pulse PG. 1t should be noted that, using the counting mechanism to count the times that the clock pulse PG maintains at a logic level mainly aims at preventing the pulse-width modulated the source clock from changing too frequently. Therefore, depending upon different application or according to different requirements on the response speed of the converter circuit, a reference value can be adopted as a basis for the times of maintaining at a certain logic level. In order to enable persons of ordinary skill in the art to implement the present invention easily.

If the converter circuit of the present invention is applied to a voltage step-down regulator, for converting a large positive input voltage into a smaller positive output voltage, such as a bulk converter circuit. Only two switches S1 and S2 need to be used for switching operation in the converter circuit 600, and the other switches S3 and S4 are prevented from switching operation. It is assumed that the capacitance of the capacitor 320 is C_{Fly}, and the capacitance of the capacitor 330 is C_{Load}, the initial output voltage is Vₒᵤₜ₃ and the output voltage Vₒᵤₜ₄ is the voltage after the voltage division effect of the capacitors 320 and 330. The reduced output voltage Vₒᵤₜ₂ is equal to Vₒᵤₜ₄=(Vₒᵤₜ₃*C_{Load}+Vin*C_{Fly})/(C_{Load}+C_{Fly}). That is, the voltage step-down operation can be done by always turning on the switch S3 and keeping the switch S4 being turned off. The efficiency of the switching operation can be significantly improved if only two switches are used in the converter circuit.

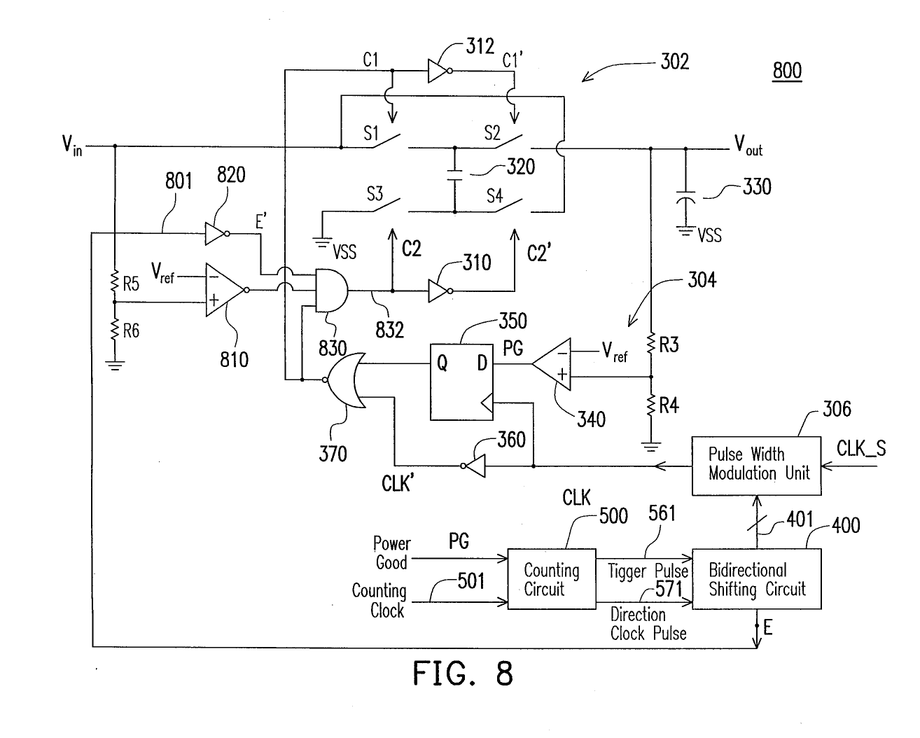

Please refer to FIG. 8, which shows schematic a diagram of a converter circuit of another embodiment of the present invention. The converter circuit 800 includes a buck-boost unit 302, a frequency modulation unit 304 and a pulse width modulation unit 306, a bidirectional shifting circuit 400, a counting circuit 500. The elements or signals of FIG. 8 with the same function as described in FIG. 3B, FIG. 4 and FIG. 5, FIG. 6 are denoted as. the same reference number, and corresponding description can be referenced above. Compared with the converter circuit 600, a circuit is added in the converter circuit 800 for the voltage a step-down function.

In the circuit, two inputs of a comparator 810 are respectively coupled to the input voltage Vᵢₙ at its positive input and to the reference voltage V_{ref} at its negative input. Output of the comparator 810 is coupled to one input of a logic AND gate 830. The control clock C1 for switching operation is also coupled to one input of the AND gate 830. The reference voltage V_{ref} is used to compare with the input voltage Vᵢₙ, if the input voltage Vᵢₙ is larger than the reference voltage V_{ref}, it means that the input voltage Vᵢₙ, is larger than the output voltage Vₒᵤₜ. The switches S3 and S4 are prevented from switching operation.

The signal 801 at the node E of the bidirectional shifting circuit 400, as shown in FIG. 4, is also coupled to third input of the AND gate 830 through a Inverter 820. The signal 801 is used to judge if the converter circuit 800 is operated as the step-down regulator. Furthermore, the signal 801 is used also used to judge whether the clock width of the control clock C1 is operated at a full clock width mode, which means that the switching operation works with the complete clock width which is the same as the source clock CLK_S. At the time, the current at the load capacitor 330 is very large, and the switches S3 and S4 are used again to the switching operation.

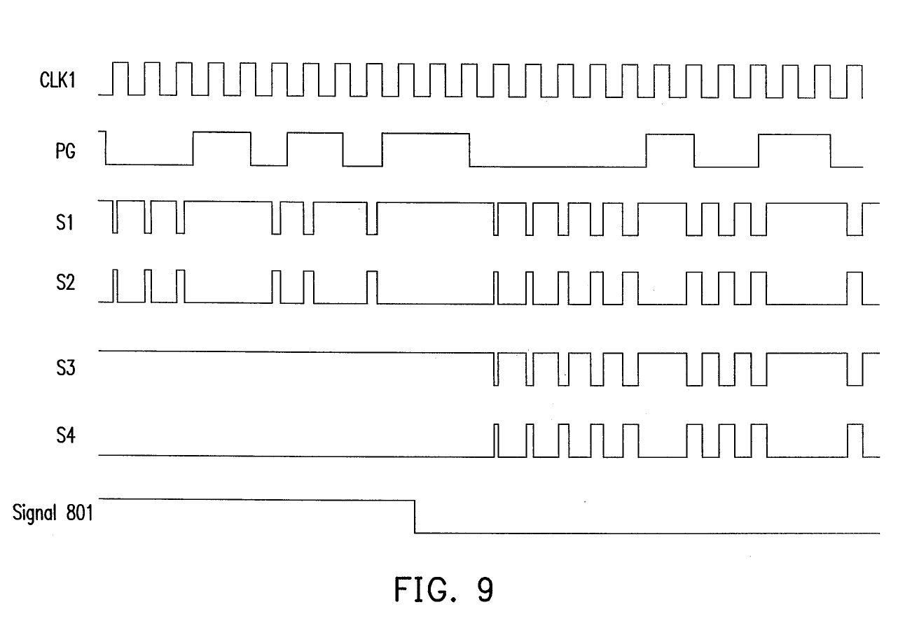

Please refer to FIG. 9, which shows a timing diagram of the converter circuit 800 using the pulse width frequency modulation of FIG. 8. During the time that the converter circuit 800 operates as the step-down regulator, the switches S3 and S4 are prevented from switching operation. However, if signal 801 at the node E of the bidirectional shifting circuit 400 of FIG. 4 is changed from logic high to logic low, the switches S3 and S4 are used again to the switching operation.

A soft start mechanism and short circuit protection are fundamental functions for the power management control design. The soft start circuit protects the integrated circuit from being burnt due to the transient over current when plugging in or out. In a converter circuit of the present invention, each time when the converter circuit is started, i.e., the output voltage Vₒᵤₜ is detected, the pulse-width modulated first clock signal is adjusted to the minimum pulse width.

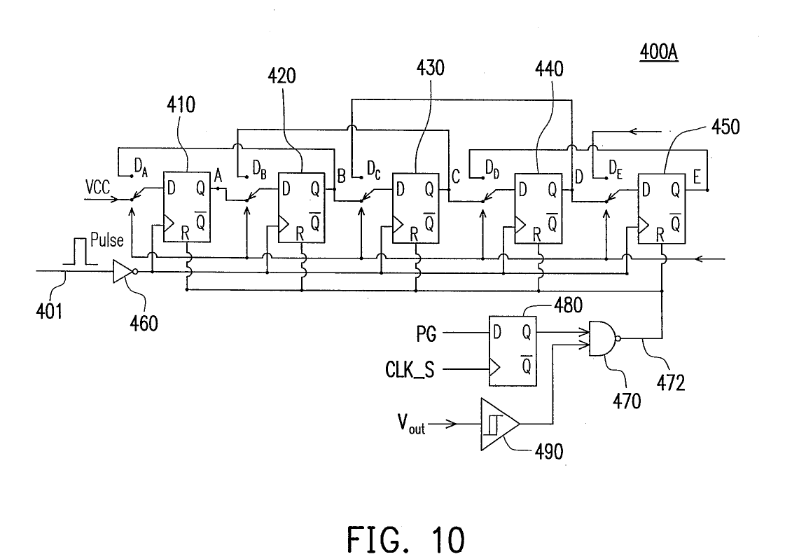

To achieve the function as mentioned, a circuit is added to the bidirectional shifting mechanism of FIG. 4, as shown in FIG. 10. The elements or signals of FIG. 10 with the same function as described in FIG. 4 are denoted as the same reference number, and corresponding description can be referenced above. The bidirectional shifting circuit 400A further includes a logic NAND gate 470, a D-type flip-flop (DFF) 480, and a voltage detector 490. The input terminal D of the DFF 480 is coupled to the power good (PG) pulse and the operation clock is coupled to the source clock CLK_S. Output at Q terminal of the DFF 480 is coupled to an input of the NAND gate 470. Output of the voltage detector 490 is coupled to another input of the NAND gate 470. Input of the voltage detector 490 is coupled to the output voltage Vₒᵤₜ. In one case that when the PG pulse is detected at the first time, or in another case that the PG pulse is detected and the output voltage Vₒᵤₜ is detected to be lower than a desired level by the voltage detector 490, the output 472 of the NAND gate 470 will reset five registers 410, 420, 430, 440 and 450 in both of the two cases, and the clock 391 with the minimum pulse width by turning on the switch SA, as in FIG. 3B, is output to the frequency modulation unit 304. The case that the output voltage Vₒᵤₜ is detected to be too low means that the output voltage Vₒᵤₜ is lower than a reset value, which is predetermined as required in the design.

The pulse width modulation mechanism provided in the present invention is gradually increasing or decreasing the pulse width of the clock applied to the frequency modulation unit for operation. That is, the increment or decrement of the pulse width of the applied clock is under control, which depends on the voltage level of the output of a buck-boost circuit. When the buck-boost circuit is designed for application, it is an issue to be concerned that a large short circuit current should be prevented from occurring in the output of the buck-boost circuit, and if it occurs, the integrated circuit with the buck-boost circuit will be seriously damaged. When the problem of short circuit is eliminated, the output of a buck-boost circuit should be smoothly started and adjusted to a correct voltage level. The buck-boost circuit of the present invention is designed to be operated by a digital control mechanism. When the case of short circuit is detected, the clock with the minimum pulse width for turning on the switch SA, as in FIG. 3B, is output to the frequency modulation unit 304 for switching operation. The simple design can significantly prevent the short circuit problem.

As memory cards for use in mobile phone devices or other portable devices are more and more popular and in rapidly spreading use. However, in considering with the power consumption, the operation voltage of the portable device is designed to be operable on different voltages, for example, 3.3 volts or 1.8 volts for preventing power consumption. For compatibility of different voltage levels of the operation voltages, the memory cards are also designed to be operable on two different power voltages (e.g. about 3.3 V and about 1.8 V), which are named as dual voltage memory devices, for example, a dual voltage secure digital (SD) card or a dual voltage reduced-sized multi-media (DV-RS MMC) card. The semiconductor memory for use in the dual voltage memory devices, for example, a flash memory card, can also be operable on two different power voltages, for example, about 3.3 V and about 1.8 V.

For providing compatibility of different operation voltages, in the case aforesaid between 3.3 V and 1.8 V for example, the operation voltages for the portable device or the memory card should be carefully regulated to operate normally. The buck-boost circuit of the present invention can be implemented as being disposed between the host and the memory card, such as a flash memory card for example, for regulating the voltages therebetween for operation.

In one embodiment, the DC-to-DC power manager can be implemented in the controller interfaced between at least one flash memory and a host which provides a host power. If the host power is 3.3 volts and the flash memory can only be operable on 1.8 volts, the controller with the DC-to-DC power manager can regulate the host power to 1.8 volts and provide it to the flash memory. If the host power is 1.8 volts and the flash memory can only be operable on 3.3 volts, the controller with the DC-to-DC power manager can regulate the host power to 3.3 volts and provide it to the flash memory.

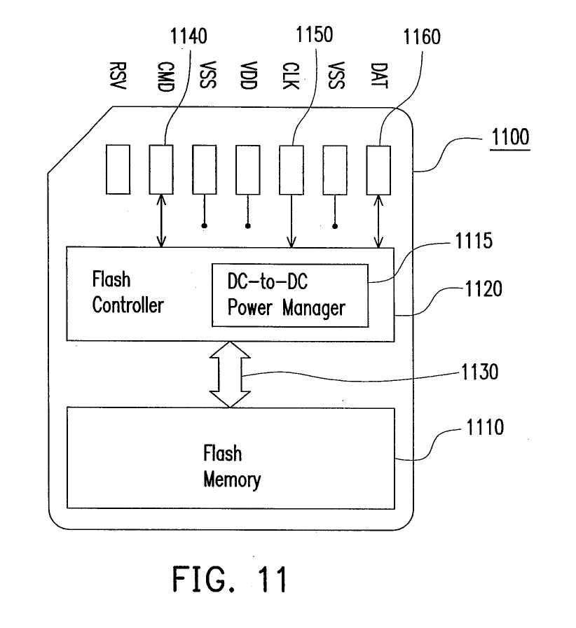

Please refer to FIG. 11, which shows a schematic diagram of a multi media card (MMC) with the DC-to-DC power manager of an embodiment of the present invention. The multi media card 1100 includes a flash memory device 1110 and a flash controller 1120 coupled to the flash memory device 1110 via an internal bus 1130. The flash controller 1120 couples to a host bus (not shown) comprising a command pin 1140, a clock pin 1150 and a data pin 1160. The term “flash memory device” in the embodiment is used interchangeably with the terms “flash memory device” and “flash memory devices.”

The DC-to-DC power manager 1120 includes a buck-boost circuit of the invention with the pulse width modulation mechanism. The noises in the output of the buck-boost circuit is significantly reduced and the multi media card (MMC) 1100 is operable on different voltages by the DC-to-DC power manager 1120.

It will be apparent to persons of ordinary art in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A converter circuit, comprising:
a voltage converting unit, for receiving an input voltage and outputting a output voltage according to the magnitude of the input voltage by switching operation based on a control clock signal;
a comparing circuit, for generating a power good pulse signal by comparing the output voltage with a reference voltage, the power good pulse signal being in a first logic state if the output voltage being larger than the reference voltage; and
a pulse width frequency modulation circuit, for receiving the power good pulse signal and a source clock signal to generate the control clock signal, wherein the pulse width of the source clock signal is varied gradually with a step-size mechanism and the frequency of the source clock signal is also changed during a period that the power good pulse signal remains in the first logic state, and the pulse width frequency modulated source clock signal is output as the control clock signal.

2. The converter circuit of claim 1, wherein during the period that the power good pulse signal remains in the first logic state, the pulse width of the source clock signal is varied gradually with a step-size in the step size-size mechanism and the frequency of the source clock signal is also changed.

3. The converter circuit of claim 1, wherein the pulse width frequency modulation circuit comprises a pulse width modulation unit, wherein the pulse width modulation unit comprise a plurality of serially connected delay units, the input of the serially connected delay units is coupled to the source clock signal, the pulse width of the source clock signal is varied gradually with the step-size mechanism by the number of the delay units the source clock signal passes, and a pulse modulated signal is generated from the pulse width modulation unit.

4. The converter circuit of claim 3, wherein the pulse width modulation unit further comprises a plurality of switches, each of which is respectively interposed between the output of each of the delay units and the output of the pulse width modulation unit through a first logic gate, by controlling the switches, the pulse modulated signal with different pulse width is generated thereby.

5. The converter circuit of claim 4, wherein the pulse width frequency modulation circuit comprises a shifting circuit, for proving a plurality of control signals to controlling the switches to being turned on or being turned off.

6. The converter circuit of claim 5, wherein the shifting circuit receives a trigger clock pulse and a directional clock pulse, the shifting circuit is triggered to operate based on the trigger clock pulse, and the control signals are shifted according to the directional clock pulse, thereby the pulse width of the pulse modulated signal is varied.

7. The converter circuit of claim 6, wherein the directional clock pulse is activated to increase the pulse width of the pulse modulated signal with a step-size, and the directional clock pulse is inactivated to decrease the pulse width of the pulse modulated signal with the step-size, and wherein the pulse width of the pulse modulated signal is varied with a predetermined range.

8. The converter circuit of claim 7, wherein the step-size is a pulse width corresponding to the delay time between two of the adjacent delay units.

9. The converter circuit of claim 7, wherein the pulse width frequency modulation circuit comprises a counting circuit for counting the times when the power good pulse signal remains in the first logic state and outputting the directional clock pulse and the trigger clock pulse, whenever the times reaches a predetermine value, the directional clock pulse from the counting circuit is activated.

10. The converter circuit of claim 9, wherein the counting circuit counts the times when the power good pulse signal remains in the first logic state based a counting clock applied to the counting circuit.

11. The converter circuit of claim 9, wherein the counting circuit comprises a latch circuit for latching the result that the times reaches the predetermine value, the directional clock pulse is activated.

12. The converter circuit of claim 1, wherein the input voltage is compared with the reference voltage, if the input voltage is larger than the reference voltage, it indicates that the voltage converting unit operates as a step-down regulator and part of a plurality of switches for the switching operation in the converter circuit are stopped from increasing the output voltage.

13. The converter circuit of claim 12, wherein when the voltage converting unit operates as the step-down regulator, one of the control signals provided by the shifting circuit is used to judge whether the control clock signal operates at a fall clock width mode, if yes, the part of the switches being stopped is used again for operation.

14. The converter circuit of claim 1, each time when the converter circuit is started, the output voltage is detected, the pulse width frequency modulated source clock signal for the first clock of the source clock signal is adjusted to the minimum pulse width.

15. The converter circuit of claim 14, each time when the pulse of the power good signal is detected, or the output voltage is lower than a level which is predetermined as required, the pulse width frequency modulated source clock signal for the first clock of the source clock signal is adjusted to the minimum pulse width.

16. The converter circuit of claim 1, wherein the voltage converting unit is a buck regulator.

17. The converter circuit of claim 1, wherein the voltage converting unit is a boost regulator.

18. The converter circuit of claim 1, wherein the voltage converting unit is a buck-boost regulator.

19. The converter circuit of claim 1, wherein the voltage converting unit employs capacitors as energy storing means for converting the input voltage to the output voltage.

20. The converter circuit of claim 1, wherein the voltage converting unit employs inductors as energy storing means for converting the input voltage to the output voltage.

21. A voltage converting method, comprising:
receiving an input voltage and outputting a output voltage according to the magnitude of the input voltage by switching operation based on a control clock signal;
generating a power good pulse signal by comparing the output voltage with a reference voltage, the power good pulse signal being in a first logic state if the output voltage being larger than the reference voltage; and
receiving the power good pulse signal and a source clock signal to generate the control clock signal, wherein the pulse width of the source clock signal is varied gradually with a step-size mechanism and the frequency of the source clock signal is also changed during a period that the power good pulse signal remains in the first logic state, and the pulse width frequency modulated source clock signal is output as the control clock signal.

22. The voltage converting method of claim 21, wherein during the period that the power good pulse signal remains in the first logic state, the pulse width of the source clock signal is varied gradually with a step-size in the step size-size mechanism and the frequency of the source clock signal is also changed.

23. The voltage converting method of claim 21, wherein during the period that the power good pulse signal remains in the first logic state, by counting the times when the power good pulse signal remains in the first logic state based on a counting clock, whenever the times reaches a predetermine value, the pulse width of the source clock signal is varied with a step-size in the step size-size mechanism and the frequency of the source clock signal is also changed.

24. The voltage converting method of claim 21, wherein further comprising the input voltage with the reference voltage, if the input voltage is larger than the reference voltage, it indicates that the voltage converting operates for step-down regulating the output voltage is stopped from increasing.

25. The voltage converting method of claim 21, each time when voltage converting is started, the pulse width of the source clock signal corresponding to the first clock of the source clock signal is adjusted to the minimum pulse width.

26. A converter circuit, comprising:
a voltage converting unit, for receiving an input voltage and outputting a output voltage according to the magnitude of the input voltage by switching operation based on a control clock signal;
a comparing circuit, for generating a power good pulse signal by comparing the output voltage with a reference voltage, the power good pulse signal being in a first logic state if the output voltage being larger than the reference voltage; and
a pulse width frequency modulation circuit, for receiving the power good pulse signal and a source clock signal to generate the control clock signal, wherein the pulse width of the source clock signal is varied gradually and the frequency of the source clock signal is also changed during a period that the power good pulse signal remains in the first logic state, and the pulse width frequency modulated source clock signal is output as the control clock signal.

27. A controller, adaptive to be interfaced between a memory device and a host which provides a host power, wherein the controller comprising a DC-to-DC power manager, for regulating the host power to a power adaptive to operation of the memory device, wherein the DC-to-DC power manager comprising:
a voltage converting unit, for receiving the host power and outputting a output voltage according to the magnitude of the host power by switching operation based on a control clock signal;
a comparing circuit, for generating a power good pulse signal by comparing the output voltage with a reference voltage, the power good pulse signal being in a first logic state if the output voltage being larger than the reference voltage; and
a pulse width frequency modulation circuit, for receiving the power good pulse signal and a source clock signal to generate the control clock signal, wherein the pulse width of the source clock signal is varied gradually with a step-size mechanism and the frequency of the source clock signal is also changed during a period that the power good pulse signal remains in the first logic state, and the pulse width frequency modulated source clock signal is output as the control clock signal.

28. The controller of claim 27, wherein the pulse width frequency modulation circuit comprises a pulse width modulation unit, wherein the pulse width modulation unit comprise a plurality of serially connected delay units, the input of the serially connected delay units is coupled to the source clock signal, the pulse width of the source clock signal is varied gradually with the step-size mechanism by the number of the delay units the source clock signal passes, and a pulse modulated signal is generated from the pulse width modulation unit.

29. The controller of claim 27, wherein the controller is a flash memory controller, and the memory device is a flash memory device.
